(19) United States
(12) Patent Application Publication
(10) Pub. No.: US 2022/0306167 A1
(43) Pub. Date: Sep. 29, 2022

(54) METHOD FOR DETECTION OF FLAT WHEEL DEFORMATION BY VIBRATION MEASUREMENT FROM RAILS

(71) Applicant: Sabri Haluk GOKMEN, Ankara (TR)

(72) Inventor: Sabri Haluk GOKMEN, Ankara (TR)

(21) Appl. No.: 17/297,534

(22) PCT Filed: May 7, 2020
(86) PCT No.: PCT/TR2020/050394

§ 371 Date: May 27, 2021

(30) Foreign Application Priority Data
Jan. 28, 2020 (TR) 2020/01306

(51) Int. Cl. B61K 9/12; G01M 17/10; G01M 13/045

(52) U.S. Cl. CPC B61K 9/12; G01M 17/10; G01M 13/045

(57) ABSTRACT

The invention relates to a method that can be used in the field of rail systems technology to detect the flat wheel deformation (31) condition in the wheels (30) of the railway vehicle (20). In particular, the invention is concerned with the detection and analysis of the mechanical vibrations, generated by the vibration waves (50) from the wheels (30) moving on the rails (10) with the vibration sensors (40). Hence, it relates to the method for determining the presence and severity of the flat wheel deformation (31) condition in the wheels (30) of the railway vehicle (20).

### TECHNICAL FIELD

The invention relates to a method that can be used in the field of rail systems technology for detecting the flat wheel deformations on the wheels of railway vehicles.

In particular, the invention relates to the method of analyzing the mechanical vibration waves generated by the wheels of the rail vehicles moving on the rails, by means of vibration sensors on the rails, thereby determining the flat wheels of the railway vehicles.

### PREVIOUS TECHNIQUES

Railway systems in the world are gaining importance day by day because they are fast, economical, environmentally friendly, safe and modern systems. One of the most important features of the rail transportation systems is that they are accepted to be the highest-safety and comfortable public transportation means. Sustaining this feature can be achieved with regular maintenance efforts to these systems. Among these efforts, the maintenance of the wheels of railway vehicles has an important place. As a result of deformations occurring on the rails, the wheels of the railway vehicles wear and lose their original geometric form. For this reason, the geometric form of the wheels in railway vehicles is important for safety. Deformations occurring on the wheels of rail vehicles are; Due to the centrifugal force in the bends, the forces transferred to the outer part of the wheel, the speed of the trains over the given speed, the train braking suddenly, the brake mechanism breaks down and a certain wheel locks on the track while moving on the rail, the fact that both rails are not at the same height level and that the wheel is hit when passing thru this elevation difference, expansions caused by climate change, pulls and many other reasons. For these reasons, the detection of deformations on the wheel and all factors threatening safety becomes more important.

In the present technique, a control is carried out using the human before the train leaves, while determining the deformity in the wheels of the railway vehicle. These officers try to provide control by means of eye or basic hand measuring devices. Performing this process with human power proves that the method is very useless. Considering the possible presence of deformities on railway vehicle wheels, huge railway accidents occur due to the difficult and not in time detection or inability of such situations and many people die because of this.

A method used in the present technique is to monitor the form of railway vehicle wheels and try to determine the flat wheels by means of an electronic camera with a computer connected. In these systems, it is attempted to observe the flat surface with special cameras and sensors that can be attached to the bottom of any railway vehicle to see the vehicle wheels. However, the fact that the camera imaging techniques can be only sufficient to detect when the flatness is large and the quality of the image decreases sharply according to the external conditions, prevents this method to be preferred.

In the present technique, the most preferred method is based on a sensor which is placed between the rail and the ground, and this sensor tries to detect the flat surface related hit of the wheel over this sensor while passing over it. The sensors used in these systems detect the hit of the wheel flat between the ground and the rail. In cases such as ground slip or adverse weather conditions or ground collapse, the information due to the wheel flat, collected by the sensors can be misleading and this information is not trusted.

The patent file U.S. Pat. No. 9,395,276, which was determined as a result of preliminary research on the current technique, was examined. In this method, measurements are made on the springs attached to the train wheels and the wheel flat is tried to be determined. This method is very heavy and expensive because it has to be applied to each wheel.

As a result of preliminary research on the current technique, the U.S. Ser. No. 10/377,397 patent file has been identified and examined. With this method, a fiber optic technology that is parallel to the rail, for example 80 cm 10 cm away from the rail and 10 cm below the surface, is buried in the ground and detects all vibration signals coming from the rail. This system can often provide misleading information in ground distortions and bad weather conditions.

Another patent encountered as a result of preliminary research on the current technique is U.S. Pat. No. 8,818,585. The explanations in the summary section of this patent are as follows: The sensor in the invention is located on the rail and in the case of a wheel flat, it shares the data it receives from the wheels. This system relates to methods used to detect flaws of the wheel becoming flat on a moving train, in particular to methods using acoustic emission sensors. The object of this invention is to detect a flaw in the flattening of the wheel on a moving train, in which it is possible to operate only by using an acoustic emission sensor, and also which can be operated by the use of a large number of acoustic emission sensors, if desired. The problem with this system is to claim detecting the beating of the wheel flat on one sensor only. In this invention, which is the subject of this patent, the beats of the wheel flat are detected continuously along the rail. In order to distinguish the local defects that may occur on the rails from the wheel flat defects, in this invention, using vibration sensors attached to the rails at multiple points on the line, it is envisaged to detect the same wheel flat finding by multiple sensors and give a valid wheel flat alarm.

As a result, the need for multi-functional, wheel flat sensing system and method, and the inadequacy of existing solutions, which compensate the disadvantages described above, are much safer and reliable than their counterparts, and the inadequacy of existing solutions has made it necessary to make an improvement in the relevant technical field.

### AIM OF THE INVENTION

The aim of the invention is to detect the vibration created by the wheels of the train in motion on the rails by a vibration sensor connected to the rail body and to reveal the vibration information caused by the flat surfaces on the train wheels, if any, from this data set.

The aim of the invention is to analyze the wheel flat related mechanical vibration signals formed on the rails caused by vehicle flat wheels with the signal sensors placed at multiple points on the line while the rail vehicle is in motion, and to determine the existence of the problem as a result of the point analysis results verifying each other.

In addition, while performing this process, it uses only the vibrations on the rail and does not evaluate the vibrations occurring from the environmental conditions or momentarily, and detects the wheel flat by detecting the continuing vibration along the line. Thus, it ensures both the safety of the railway vehicle and prevents the railroads from being damaged by flat wheels hitting the rails, thus preventing major railway accidents.

Another aim of the invention is to eliminate the shortcomings of the point analysis made with electromagnetic or electromechanical test devices and to ensure that the wheel flat deformations along a line can be detected easily, at any time and quickly. Continuous collection and evaluation of wheel flat deformity information is a very important difference. As a result, the rail vehicle is immediately stopped and loss of life and property is prevented in order not to suffer a greater deformation and damage to the rails due to the wheel flat deformations.

Another aim of the invention is to incorporate the rail temperature information into the detection process, thereby eliminating the possibility of erroneous results.

Another aim of the invention is to determine how strong the strike is according to the train speed and rail temperature by analyzing and processing the vibration signals all along the rail line instead of measuring only in certain areas as in the case of other electronic and camera sensors used in the present technique.

Another aim of the invention is the determination of the flat wheel deformation emerging as a result of friction, sudden brake etc., by measuring the vibration waves in the rail created by the wheels moving on the rail in three axes (x, y, z).

Another aim of the invention is to prevent errors in the process of perceiving the presence and severity of the flat wheel deformation. In the invention, the signals arising from the effects of local rail deformations such as broken, fractured or cracked segments on the rail are not considered because they are not continuous. In other words, the system constantly collects and processes data.

Another aim of the invention is to provide ease in terms of cost and usage and to eliminate the disadvantages of some other systems such as very high sensitivity sensors, high resolution and fast shooting cameras and similar systems, with its simple structure.

Another purpose of the invention is that, it is able to detect the flat wheel defects of the railway vehicles moving on all lines, especially on high-speed railway lines, at the stage of its formation or when it has just been created and can make necessary warnings to the train in advance.

In accordance with the mentioned purposes, the invention, which eliminates the negativities in the existing embodiments, can be used in the field of rail systems technology, in the detection of the flat wheel deformations occurring in the railway vehicles; It is a method that enables sensing the vibrations created by the flat wheels of the train in motion on the rails by a vibration sensor connected to the rail body and revealing the vibration information caused by the flat surfaces on the train wheels, if any, from this data set.

The structural and characteristic features and all the advantages of the invention will be more clearly understood by the FIGURES given below and the detailed description written with reference to these FIGURES. For this reason, the evaluation should be made by taking these FIGURES and detailed explanation into consideration.

### FIGURES TO HELP UNDERSTAND THE INVENTION

FIG. 1; This is a drawing that schematically shows the working principle of the method used in this invention that can be used to detect the flat surface deformations on the wheels of the railway vehicles in motion.

### REFERENCE NUMBERS

10. Rail
20. Railway Vehicle
30. Wheel
31. Flat Wheel Deformation
40. Vibration Sensor
50. Vibration Waves

### DETAILED DESCRIPTION OF THE INVENTION

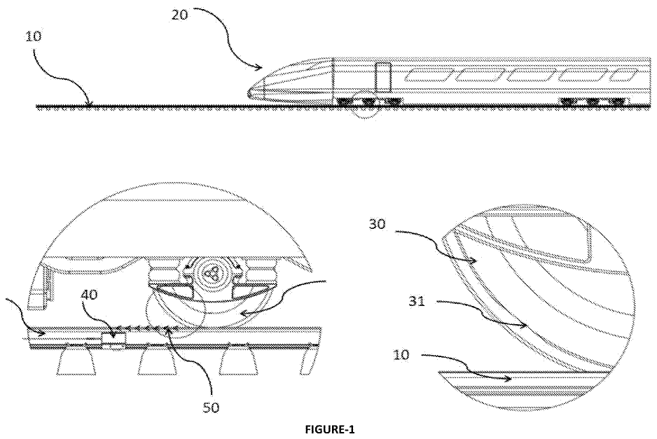

In the FIG. 1, the drawing showing schematically, the working principle of the method that can be used in determining the flat wheel deformations (31) formed on the wheels (30) of the railway vehicles (20) of the present invention is given.

The vibration sensor (40) module mounted on the rails (10) are used to measure the vibration waves (50) caused by the wheels (30) with flat wheel deformation (31) of the approaching or moving away railway vehicle (20), in three axis (x, y, z). At the end of the fft (fast fourier transformation) analysis of the data set obtained as a result of the measurement of these vibration waves (50), a flat wheel deformation (31) related signal, which is caused by the wheel (30), by considering the speed of the railway vehicle (20) and the temperature of the rail (10), is revealed to exist. As a result of the perception of the frequency, the presence of the flat wheel deformation (31) is decided. Then, the severity of flat wheel deformation (31) is defined by the conversion of fft data, specific to a certain frequency band, back to the time domain again with a reverse fft (inverse fast fourier transformation) operation and normalizing this new time domain dataset to the value set at a predetermined rail (10) temperature level.

The intensity of the vibration on the rails (10) due to the movement of the railway vehicle (20) varies continuously depending on the temperature of the rail (10). It is possible to determine the amount of this change by measuring the temperature of the rail (10). After the measured vibration values are first corrected according to the correlation values determined previously with the temperature of the rail (10) measured, this corrected data set containing the amplitude information is transferred to the frequency domain by fft operation. In the frequency spectrum data set, obtained as a result of this conversion process, the presence of the frequency of the flat wheel deformation (31) signal is examined according to the speed of the railway vehicle (20) on the rail (10). After the determination of the presence of the flat wheel deformation (31) from this frequency domain dataset, the dataset around the specific frequency is transformed back into the time domain with the reverse fft process and this converted dataset is normalized according to the real time measured rail (10) temperature to get the correct flat wheel deformation (31) severity level value.

In the invention, the amount of flat wheel deformation (31) beat to the rail (10) intensity is determined by using the flat wheel deformation (31) reference values which have been previously determined and normalized to the temperature of the rail (10).

In order to better understand the invention, the following example has been deemed suitable as an example:

Assuming that the circumference of the wheel (30) of a railway vehicle (20) is, for example, 200 cm, a 34.72 Hz component is added to the vibration signal on the rail (10) generated by the high-speed railway vehicle (20) traveling at 250 km per hour speed on the rail (10). While this component indicates the presence of the wheel (30) with a flat wheel deformation (31) condition, the amplitude of the signal at this frequency will also give information about the force applied to the rail (10) by the flat wheel deformation (31) condition of the wheel.

In the Analysis Result-1, the vibration data set recorded on the z-axis of the rail (10) created by a railway vehicle (20) without a flat wheel deformation (31) on the rail (10) appears. The spectrum image obtained after the fft analysis of this data set is given in Analysis Result-2 below.

Above, in Analysis Result-2, there is a main component around 1700 Hz in the frequency spectrum image, and this component is a basic frequency component of the vibrations created by the wheels (30) on the rail (10) of a railway vehicle (20) without a flat wheel deformation (31) surface.

In the following Analysis Result-3, the vibrations created by a railway vehicle (20), which is moving on the rail (10) with a flat wheel deformation (31), is recorded by the vibration sensor (40) is shown.

The graph shown in Analysis Result-4 below belongs to the frequency spectrum dataset obtained after the fft conversion of the data set presented in the above graph shown in Analysis Result-3.

The signal, which is seen in the lower left corner of the graph in Analysis Result-4 has a peak around 35 Hz, which belongs to the wheel (30) with a flat wheel deformation (31) surface of the railway vehicle (20) that creates a distinct frequency signal component in the measured and transformed data set. The value obtained as a result of vector collection of continuous measurements of this signal received on the rail (10) by the vibration sensor (40) positioned on the rail (10) in three axes, determines the presence and angle of the flat wheel deformation (31) surface on the wheel (30).

In determining the beat intensity of this flat wheel deformation (31), the data set of this frequency signal region, which is seen in the lower left corner of the graph in Analysis Result-4 which has a peak around 35 Hz is transformed back into the time domain with a reverse fft operation as shown in Analysis Result-5. The graph below is used to determine the intensity level of the flat wheel deformation (31) beats on the rail (10).

While the presence of this signal points to the flat wheel deformation (31) condition on the wheel (30) in the set of the railway vehicle (20), the intensity of the signal will be proportional to the flat wheel deformation (31) beat force applied to the rail (10) by this wheel (30). After calculating the change of the amplitude of flat wheel deformation (31) signal obtained from the rail (10) with the temperature of the rail (10), it will be possible to calculate the flat wheel deformation (31) beat force more realistically. After all, a correlation study of the change of the vibration signal with the temperature of the rail (10) on datasets belonging to various flat wheel deformation (31) conditions collected from the rails (10) and processed by an artificial intelligence algorithm, based on the regression analysis method, to learn the signal change behavior against then temperature variations on the rails (10) will produce very realistic and sensitive flat wheel deformation (31) measurement results, both in quantity and quality terms.

In summary, in the field of rail systems technology, the invention can be used to determine the flat wheel deformation (31) condition on the wheels (30) of the railway vehicle (20), moving on the rails (10). The invention consists of the steps including; the sensing of the mechanical vibration waves (50) resulting from the contact of the non-deformed wheels (30) with the vibration sensors (40) over the rail (10), the sensing of the additional mechanical vibration waves (50) resulting from the contact of the deformed wheel (30) with the flat wheel deformation (31) condition with the vibration sensors (40) over the rail (10), combining these two vibration wave (50) datasets and transferring this combined set to the frequency domain using fft (fast fourier transformation) conversion method and analyzing this frequency domain dataset for searching the existence of the frequency components pointing to the flat wheel deformation (31) condition on the wheels (30) of the moving railway vehicle (20) on the rails (10).

In the method, that can be used for determining the flat wheel deformation (31) condition on the wheels (30) of the railway vehicle (20), moving on the rails (10), the measurements of the vibration waves (50) coming from the wheels (30) in three axes (x, y, z), in order to analyze the impact angle information within the beat signal caused by the flat wheel deformation (31) condition on the wheels (30) by using the vibration sensors (40). Again, the determination of the flat wheel deformation (31) condition is done by placing the vibration sensors (40) on the body of the rail (10) and measuring the vibration values in three axes (x, y, z) and collecting the related values drawn from the frequency spectrum data obtained at the end of the fft process, in vector form. In the determination of the flat wheel deformation (31) condition on the wheels (30) of the railway vehicle (20) the speed of the railway vehicle (20) is used to perform a proper fft analysis. In determination of the flat wheel deformation (31) condition on the wheels (30) of the railway vehicle (20) the vibration measurements are made continuously in three axes with vibration sensors (40) placed on the body of the rail (10) so that the flat wheel deformation (31) condition formed in the wheels (30) of the railway vehicle (20) can be detected immediately. In this section, instant detection is provided by taking continuous measurements.

In the determination process of the impact force of the flat wheel deformation (31) condition on the wheels (30) of the railway vehicle (20) moving on the rail (10) by the method that can be used to determine the flat wheel deformation (31) condition on the wheels (30) of the railway vehicle (20) as well; measuring the rail (10) temperature information and normalizing the vibration signal amplitude dataset, obtained from the vibration sensor (40) connected to the rail (10), to a predetermined temperature value, determining the presence of the flat wheel deformation (31) condition by fft analysis, applying a reverse fft operation on the frequency spectrum data set in the frequency band related to the flat wheel deformation (31) condition of the wheel (30), then the normalization of the dataset obtained after this reverse fft operation against the rail (10) temperature information obtained by the vibration sensor (40) in real time to determine the beat intensity of the flat wheel deformation (31) steps are followed.

1. The invention is a method that can be used in the field of rail systems technology to detect the flat wheel deformations (31) on the wheels (30) of the railway vehicle (20) and characterized with the following features in order of process;
the railway vehicle (20) moves on the rails (10),
detecting the mechanical vibration waves (50) that occur as a result of the contact of the wheels (30) that are not deformed with the rail (10) while the railway vehicle (20) is in motion, with the vibration sensors (40) on the rail (10),
detecting additional mechanical vibration waves (50) on the rail (10) by vibration sensors (40) on the rail (10), caused by the wheel (30) with flat wheel deformation (31) condition of the railway vehicle (20) moving on the rail (10),
the combination of the vibration wave (50) signals from the wheels (30) without the flat wheel deformation (31) condition with the vibration wave (50) signals originating from the flat wheel deformation (31) condition,
transferring the data set resulting from the merger to the frequency domain using the fft (fast fourier transformation) analysis method,
analyzing the presence of the frequency of the flat wheel deformation (31) condition on the wheels (30) of the railway vehicle (20) in the obtained frequency spectrum data set and ensuring the correct determination.

2. The method that can be used for determining the flat wheel deformation (31) in the wheels (30) of the railway vehicle (20) according to claim-1, and its feature; characterized in that the vibration waves (50) coming from the wheels (30) are measured on three axes (x, y, z) by using vibration sensors (40) in order to analyze the beat angle information in the beat signal from the wheels (30).

3. The method that can be used determining the flat wheel deformation (31) condition in the wheels (30) of the railway vehicle (20) according to claim 1, and its feature; the value obtained as a result of the determination of the flat wheel deformation (31) condition by measuring the vibration values on three axes (x, y, z) by placing the vibration sensors (40) on the body of the rail (10), converting this 3-axis measured values by an fft conversion process and adding the related frequency domain 3-axis dataset in vector form. It is characterized by the use of this vector sum values to determine the flat wheel deformation (31) condition.

4. The method that can be used for determining the flat wheel deformation (31) condition in the wheels (30) of the railway vehicle (20) according to claim-1, and its feature; in determining the flat wheel deformation in the wheels (30) of the railway vehicle (20); It is characterized by the use of the speed of the railway vehicle (20) to perform the fft analysis.

5. The method that can be used for determining the flat wheel deformation (31) in the wheels (30) of the railway vehicle (20) according to claim 1, and its feature; characterized in that the vibration measurements are carried out in three axes (x, y, z) continuously with vibration sensors (40) placed on the body of the rail (10) so that the flat wheel deformation (31) condition developed in the wheels (30) of the railway vehicle (20) can be instantly detected.

6. The method that can be used in determining the flat wheel deformation (31) in the wheels (30) of the railway vehicle (20) according to claim 1, and its feature; in the determination of the impact force of the flat wheel deformation (31) in the wheels (30) of the railway vehicle (20) applied to the rail (10), characterized by the process steps;
normalizing the vibration signal amplitude value, measured according to the rail (10) temperature information, to a predetermined temperature value,
determination of the presence of the flat wheel deformation (31) condition on the wheel (30), by fft analysis,
determination of the impact strength of the flat wheel deformation (31) condition after the normalization of the flat wheel deformation (31) signal obtained by applying the reverse fft operation to the frequency spectrum data set in the frequency band in relation to the flat wheel deformation (31) condition on the wheel (30) according to the rail (10) temperature information of the time domain amplitude data set.
